(19) United States
(12) Patent Application Publication
(10) Pub. No.: US 2013/0215529 A1
(43) Pub. Date: Aug. 22, 2013

(54) DRIVE CONTROL APPARATUS, DRIVE CONTROL METHOD, AND STORAGE APPARATUS

(71) Applicant: FUJITSU LIMITED, (US)

(72) Inventor: Yoshiaki OCHI, Kawasaki (JP)

(73) Assignee: FUJITSU LIMITED, Kawasaki-shi (JP)

(21) Appl. No.: 13/845,595

(22) Filed: Mar. 18, 2013

Related U.S. Application Data
(63) Continuation of application No. PCT/JP2010/067230, filed on Oct. 1, 2010.

(51) Int. Cl. G11B 20/18

(52) U.S. Cl. CPC G11B 20/18
USPC 360/55

(57) ABSTRACT

A drive control apparatus includes a management unit, a detection unit, and an information unit. The management unit identifies a data write position on a tape onto which data is written sequentially, and manages correspondences between first addresses including an address larger than an address which is managed by an upper apparatus connected to the drive control apparatus and second addresses for making the upper apparatus identify the data write position on the tape. The detection unit detects that a drive which writes the data onto the tape fails in writing the data. The information unit informs the upper apparatus of a second address of a position on the tape at which write fails on the basis of detection by the detection unit.

### CROSS-REFERENCE TO RELATED APPLICATION

This application is a continuation application of International Application PCT/JP2010/067230 filed on Oct. 1, 2010 which designated the U.S., the entire contents of which are incorporated herein by reference.

### FIELD

The embodiments discussed herein are related to a drive control apparatus, a drive control method, and a storage apparatus.

### BACKGROUND

A magnetic tape is known as a storage device used for, for example, backing up data.

A computer which manages writing to a magnetic tape manages a data write position on the magnetic tape. By doing so, the computer performs data recovery in the case of a write error occurring. For example, a technique for specifying a position on a tape at which a write error occurs and writing data again from the specified position is known as a recovery method.
Japanese Laid-open Patent Publication No. 05-54551
Japanese Laid-open Patent Publication No. 2005-122433

Tape capacity which a host computer is able to recognize is determined by the specifications of an OS (Operating System), middleware, or the like installed on the computer, the number of tape tracks along which magnetic heads of a tape drive is able to write, or the like.

For example, it is assumed that an OS manages tape capacity by a 22-bit value (3FFFFFh) and that data is written onto a tape by the block (1 block is 32 kB). Then a host computer is able to manage a tape capacity of 137 GB (=2²²×32 kB).

In recent years, however, large capacity tapes the storage capacity of which exceeds, for example, 800 GB have mainly been used.

For example, it is assumed that an OS which manages tape capacity by a 22-bit value is used for writing onto a tape the storage capacity of which is 800 GB. In this case, it is possible to write data onto the tape in excess of a capacity of 137 GB which the OS is able to manage.

However, if a write error occurs at a position beyond the capacity which the OS is able to manage, then the OS is unable to specify the position at which the write error occurs, and perform data recovery. As a result, from the viewpoint of risk management a tape is used within the capacity which the OS is able to manage, and this prevents effective use of a storage area of a large capacity tape.

### SUMMARY

According to an aspect, there is provided a drive control apparatus. The drive control apparatus includes a management unit which identifies a data write position on a medium to which data is written sequentially and which manages correspondences between first addresses including an address larger than an address which is managed by a connected apparatus connected to the drive control apparatus and second addresses for making the connected apparatus identify the data write position on the medium, a detection unit which detects that a drive which writes the data onto the medium fails in writing the data, and an information unit which informs the connected apparatus of a second address of a position on the medium at which write fails based on detection by the detection unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for giving the outline of a drive control apparatus according to a first embodiment;

FIG. 2 is a block diagram of the structure of a library system according to a second embodiment;

FIG. 3 is a block diagram of the structure of a magnetic tape apparatus;

FIG. 4 is a block diagram of the functions of a drive control unit;

FIG. 5 indicates drive type management information;

FIG. 6 indicates virtual block ID ratio management information;

FIG. 7 indicates block ID management information;

FIG. 8 is a flow chart of a process performed by the drive control unit;

FIG. 9 is a flow chart of command processing;

FIG. 10 is a flow chart of WR command processing;

FIG. 11 is a flow chart of RDBID command processing;

FIG. 12 is a flow chart of LOCATE command processing;

FIG. 13 is a flow chart of re-WR command processing; and

FIG. 14 is a concrete example of a process performed in the library system.

### DESCRIPTION OF EMBODIMENTS

Embodiments will now be described in detail with reference to the accompanying drawings, wherein like reference numerals refer to like elements throughout.

A drive control apparatus according to an embodiment will be described first, and then an embodiment will be described more concretely.

### First Embodiment

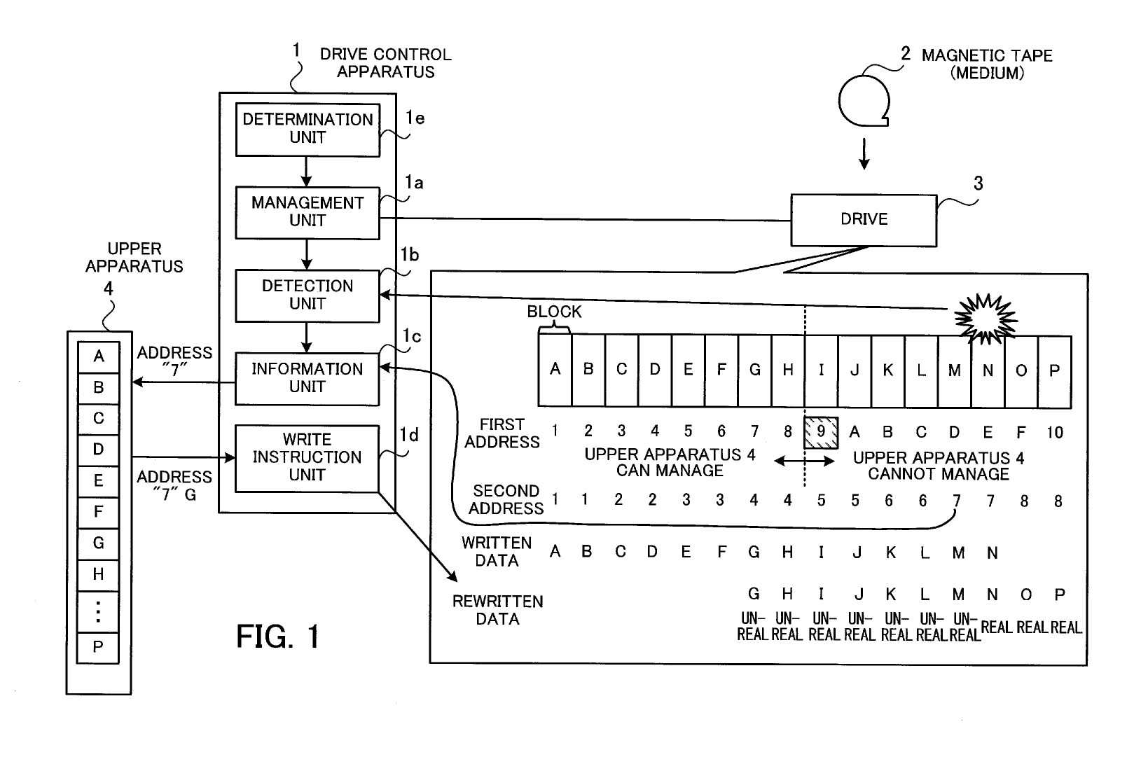

FIG. 1 is a view for giving the outline of a drive control apparatus according to a first embodiment.

A drive control apparatus (computer) 1 according to a first embodiment controls a drive 3 in accordance with instructions from an upper apparatus 4.

The drive control apparatus 1 is connected to the drive 3 and the upper apparatus 4. The upper apparatus 4 assigns an area on a magnetic tape (hereinafter simply referred to as the tape) 2 to a piece of data, for example, by the block. One block is 32 kB. The upper apparatus 4 manages one block written onto the tape 2 by one address.

An address on the tape 2 which the upper apparatus 4 is able to manage depends on the specifications of an OS, middleware, or the like, the number of tracks on the tape 2 along which magnetic heads of the drive 3 is able to write, or the like.

In the first embodiment the drive control apparatus 1 informs the upper apparatus 4 in advance of the number of tracks on the tape 2 along which the magnetic heads of the drive 3 is able to write. On the basis of the number of tracks of which the upper apparatus 4 is informed, the upper apparatus 4 determines an address on the tape 2 which the upper apparatus 4 is able to manage. “the upper apparatus 4 is able to manage” means that the upper apparatus 4 is able to specify a write position on the tape 2. For example, if the number of tracks is 36, then the upper apparatus 4 determines that it is able to manage the tape 2 up to 22 bits, that is to say, up to the address “3FFFFFh”. In the first embodiment one block is 32 kB, so the upper apparatus 4 is able to manage a capacity of 137 GB (=2²²×32 kB). For example, if the tape 2 has a capacity of 256 GB, then the upper apparatus 4 is unable to manage an area beyond 137 GB.

For convenience of explanation it is assumed that in the first embodiment the tape 2 has a capacity of 512 kB (=16 blocks×32 kB). Furthermore, it is assumed that the upper apparatus 4 is able to manage a capacity of 256 kB (=2³×32 kB), that is to say, up to the address “8h”. If the upper apparatus 4 is informed of one of the addresses “1h” through “8h” as a point at which a write error has occurred, then the upper apparatus 4 is able to specify the point at which the write error has occurred. However, the upper apparatus 4 is unable to manage an area beyond 256 kB, that is to say, from the address “9h” on. Even if the upper apparatus 4 is informed of the address “9h” as a point at which a write error has occurred, the upper apparatus 4 is unable to specify the point at which the write error has occurred.

The upper apparatus 4 gives the drive 3 instructions to write onto the tape 2 data A through P which the upper apparatus 4 has and which are separated according to blocks.

The drive control apparatus 1 gives the drive 3 instructions to write onto the tape 2 the data A through P which the upper apparatus 4 instructs the drive 3 to write. In accordance with the instructions from the drive control apparatus 1 the drive 3 writes the data A through P sequentially onto the tape 2.

The drive control apparatus 1 includes a management unit 1a, a detection unit 1b, an information unit 1c, and a write instruction unit 1d.

The management unit 1a manages first addresses and second addresses. Each first address is associated with one block written onto the tape 2. The drive control apparatus 1 is able to identify a write position on the tape 2 by a first address. Furthermore, the first addresses include the addresses “9h” through “10h” which the upper apparatus 4 is unable to identify. A unit of the first addresses is the same as a unit by which the upper apparatus 4 manages addresses.

The second addresses are used for making the upper apparatus 4 identify a data write position on the tape 2. In the first embodiment the second addresses are the addresses “1h” through “8h” obtained by associating two blocks written onto the tape 2 with one address. By adopting these addresses, the upper apparatus 4 is able to identify any of the second addresses of which it is informed.

In addition, the drive control apparatus 1 is able to include a determination unit 1e which determines the first addresses and the second addresses.

The determination unit 1e determines the second addresses in a determined ratio to the first addresses according to the maximum capacity of the tape 2. For example, if the maximum capacity of a tape mounted on the drive 3 is 800 GB, then the determination unit 1e determines the second addresses so as to manage by one address eight blocks written onto the tape. This makes it possible to manage a capacity of 1024 GB (=2²²×32 kB×8) by the second addresses.

The detection unit 1b detects that the drive 3 fails in writing data onto the tape 2. “the drive 3 fails in writing data onto the tape 2” means that the drive 3 is unable to write data to a block of the tape 2 because of, for example, the faulty tape 2 or drive 3. In FIG. 1, the detection unit 1b detects that the drive 3 fails in writing the data N.

The detection unit 1b specifies a second address at which writing fails on the basis of the correspondences between the first addresses and the second addresses managed by the management unit 1a, and informs the information unit 1c of it. The information unit 1c may have the function of specifying a second address.

When the detection unit 1b detects a failure in writing, the information unit 1c informs the upper apparatus 4 of a second address on the tape 2 at which the failure in writing occurs.

In FIG. 1, the detection unit 1b detects that the drive 3 fails in writing the data N. Therefore, the information unit 1c informs the upper apparatus 4 of the second address “7h” corresponding to the data N. The upper apparatus 4 is unable to determine whether it is the first address “7h” or the second address “7h”, so the information unit 1c simply informs the upper apparatus 4 of the address “7h”.

The upper apparatus 4 is informed of the address “7h”, so the upper apparatus 4 gives the drive control apparatus 1 instructions to write data again from the address “7h”, and transmits to the drive control apparatus 1 the data G at the address “7h” which the upper apparatus 4 manages.

In accordance with the instructions from the upper apparatus 4 to write data onto the tape 2 from the address “7h”, the write instruction unit 1d instructs the drive 3 not to write data onto the tape 2 from the first address “7h” corresponding to the address “7h” of which the upper apparatus 4 is informed to the first address “Dh” corresponding to the second address “7h”, and instructs the drive 3 to write data onto the tape 2 from the first address “Eh”.

To be concrete, the write instruction unit 1d determines that data written from the upper apparatus 4 starts from the first address “7h” and determines how many pieces of data are transmitted from the first address “7h” to the first address “Eh” at which writing is started. As a result, the write instruction unit 1d determines that seven pieces of data are transmitted from the first address “7h” to the first address “Dh”. The write instruction unit 1d then instructs the drive 3 to write an eighth piece of data to the first address “Eh”.

The data G received from the upper apparatus 4 is already written onto the tape 2 normally, so the write instruction unit 1d does not instruct the drive 3 to write the data G, and informs the upper apparatus 4 that the data D is written normally. After that, the data H, the data I, and so on are transmitted sequentially from the upper apparatus 4. However, these pieces of data are already written onto the tape 2 normally, so the write instruction unit 1d does not instruct the drive 3 to write these pieces of data, and informs the upper apparatus 4 that these pieces of data are written normally. By doing so, a rewriting process is performed at high speed. After that, when the data N is transmitted from the upper apparatus 4, the write instruction unit 1d instructs the drive 3 to write the data N onto the tape 2. In addition, the write instruction unit 1d instructs the drive 3 to sequentially write onto the tape 2 data accepted from the upper apparatus 4.

In FIG. 1, data which is not written is indicated by “unreal” and data which is written is indicated by “real”.

Even if writing data fails in an area which the upper apparatus 4 is unable to manage, the above drive control apparatus 1 specifies the area by a second address and informs the upper apparatus 4 of the second address. This makes it possible for the upper apparatus 4 to rewrite the data. This makes it possible to use a storage area of the tape 2 effectively and increase a usage area of the tape 2.

In the above description of the first embodiment, when the detection unit 1b detects a failure in writing, the information unit 1c informs the upper apparatus 4 of a second address on the tape 2 at which the failure in writing occurs. However, if the detection unit 1b detects a failure in writing in an area which the upper apparatus 4 is unable to manage, the information unit 1c may inform the upper apparatus 4 of a second address. In addition, if the detection unit 1b detects a failure in writing in an area which the upper apparatus 4 is able to manage, the information unit 1c may inform the upper apparatus 4 of a first address. Furthermore, in accordance with instructions from the upper apparatus 4 to write onto the tape 2 data for which an address is designated, the write instruction unit 1d may instruct the drive 3 to write the data onto the tape 2 from the designated address. A distinction is made between a process performed in the case of a failure in writing being detected in an area which the upper apparatus 4 is able to manage and a process performed in the case of a failure in writing being detected in an area which the upper apparatus 4 is unable to manage. As a result, when a failure in writing is detected in an area which the upper apparatus 4 is able to manage, it is possible to perform a process for rewriting data onto the tape 2 at high speed.

Furthermore, in the first embodiment the method of managing first addresses and second addresses in a fixed ratio is described. However, another method may be used. For example, the method of setting a second address by subtracting a fixed number from a first address may be used. That is to say, it is preferable to set a second address so that the drive control apparatus 1 is able to specify a position on the tape 2 which the upper apparatus 4 is unable to manage.

In addition, in the first embodiment the information unit 1c informs the upper apparatus 4 of the second address “7h” of the data N. However, the information unit 1c may inform the upper apparatus 4 of another address. For example, regardless of a position at which a failure in writing is detected, the information unit 1c may inform the upper apparatus 4 of the maximum address “8h” of the addresses which the upper apparatus 4 is able to identify. In this case, the upper apparatus 4 gives the drive control apparatus 1 instructions to write data again from the address “8h”. At this time the write instruction unit 1d instructs the drive 3 not to write data onto the tape 2 from the first address “8h” corresponding to the address “8h” of which the upper apparatus 4 is informed to the first address “Dh”, and instructs the drive 3 to write data onto the tape 2 from the first address “Eh”. This makes it possible to reduce the number of pieces of data which the upper apparatus 4 transmits.

The detection unit 1b, the information unit 1c, the write instruction unit 1d, and the determination unit le may be realized by the functions of a CPU (Central Processing Unit) included in the drive control apparatus 1. Furthermore, the correspondences between first addresses and second addresses stored in the management unit 1a may be stored in a RAM (Random Access Memory), an HDD (Hard Disk Drive), or the like included in the drive control apparatus 1.

An embodiment will now be described more concretely.

### Second Embodiment

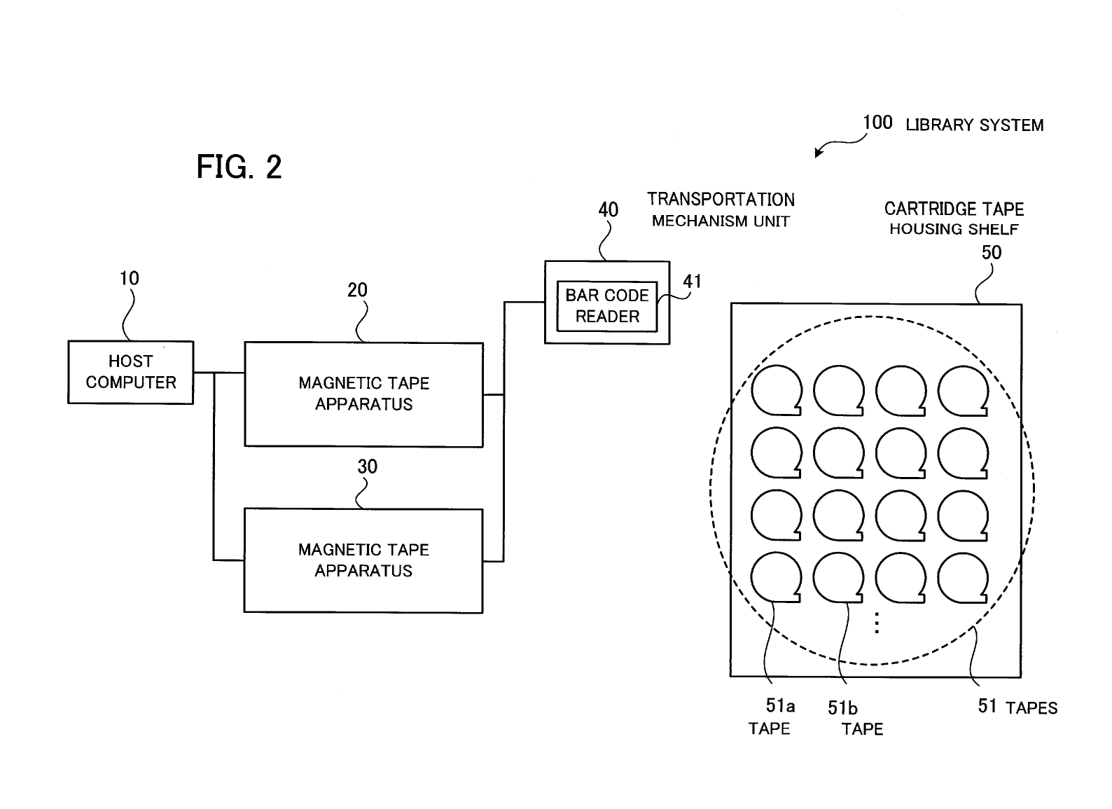

FIG. 2 is a block diagram of the structure of a library system according to a second embodiment.

A library system 100 includes a host computer 10, magnetic tape apparatus 20 and 30, a transportation mechanism unit 40, and a cartridge tape housing shelf 50.

The magnetic tape apparatus 20 and 30 are examples of a storage apparatus. The magnetic tape apparatus 20 and 30 are connected to the host computer 10 via a communication line such as a LAN.

The host computer 10 is connected to the magnetic tape apparatus 20 and 30. The host computer 10 assigns an area of a tape 51 mounted on the magnetic tape apparatus 20 or 30 to a piece of data by the block. One block is 32 kB. The host computer 10 manages one block written onto a tape by one physical block ID. For example, a tape based on the LTO (Liner Tape Open) standards is used.

In this embodiment the magnetic tape apparatus 20 or 30 informs the host computer 10 in advance of the number of tracks on a tape 51 along which magnetic heads of a tape drive described later is able to write. The host computer 10 determines a physical block ID up to which it is able to manage the tape 51 according to the number of tracks of which it is informed. For example, if the number of tracks is 36, then the host computer 10 determines that it is able to manage the tape 51 up to 22 bits, that is to say, up to the physical block ID “3FFFFFh”. In this case, one block is 32 kB, so the host computer 10 is able to manage a capacity of 137 GB (=2²²×32 kB). On the other hand, if the number of tracks is 128, then the host computer 10 determines that it is able to manage the tape 51 up to 32 bits, that is to say, up to the physical block ID “FFFFFFFFh”. In this case, the host computer 10 is able to manage a capacity of 140 TB (=2³²×32 kB).

The host computer 10 outputs a command for controlling the magnetic tape apparatus 20 or 30.

In addition, when the host computer 10 receives an error (hereinafter referred to as a data write error) which indicates that data is unable to be written from the magnetic tape apparatus 20 or 30 to a tape because of a failure in the magnetic tape apparatus 20 or 30 itself, a defect in the tape, or the like, the host computer 10 performs a DDR (Dynamic Drive Recovery) process. With the DDR process the host computer 10 issues a RDBID (Read Block ID) command and a LOCATE command described later to the magnetic tape apparatus 20 or 30 which informs the host computer 10 of the data write error. By doing so, data is written again from a position at which the data write error has occurred.

In accordance with a command outputted from the host computer 10, the magnetic tape apparatus 20 or 30 writes data to or reads out data from a tape 51 mounted thereon.

The transportation mechanism unit 40 includes a mechanism which transports a tape between the cartridge tape housing shelf 50 and the magnetic tape apparatus 20 or 30 in accordance with instructions from the magnetic tape apparatus 20 or 30 based on a request from the host computer 10.

The transportation mechanism unit 40 includes a bar code reader 41. The bar code reader 41 reads a bar code stuck on a tape 51a, and acquires information, such as a tape name, regarding it. For example, when the tape 51a is put on the cartridge tape housing shelf 50 or at any timing designated by a user, the transportation mechanism unit 40 uses the bar code reader 41 for scanning the inside of the cartridge tape housing shelf 50 and reading a bar code stuck on a tape. By doing so, the transportation mechanism unit 40 confirms whether or not there is a tape 51. The transportation mechanism unit 40 then transmits a confirmation result to the magnetic tape apparatus 20 the 30. The magnetic tape apparatus 20 and 30 acquire the confirmation result and generate or update information for managing a tape.

The cartridge tape housing shelf 50 houses a plurality of tapes 51 including tapes 51a, 51b, and so on at determined positions. The plurality of tapes 51 housed in the cartridge tape housing shelf 50 may belong to a plurality of generations. In the second embodiment the plurality of tapes 51 housed in the cartridge tape housing shelf 50 belong to the first generation (G1) through the fourth generation (4G).

Each of the plurality of tapes 51 housed in the cartridge tape housing shelf 50 includes a cartridge memory which is a non-contact type IC tag for storing statistical information such as a mount history, the amount of recorded data, and error information. A bar code label created based on a fixed naming rule is stuck on each tape 51 and it is housed in the cartridge tape housing shelf 50. The position of each tape 51 is determined. After the tape 51a is used, it is housed at the same position where it was housed.

In response to a request to write data to or read data from a tape 51 (tape 51a, for example) which the host computer 10 has, the magnetic tape apparatus 20 or 30 acquires the tape 51a from the cartridge tape housing shelf 50 by the transportation mechanism unit 40, transports it to a drive unit described later, and mounts it on the drive unit. The magnetic tape apparatus 20 or 30 then writes the data to or reads the data from the tape 51a mounted on the drive unit in response to the request from the host computer 10. After the magnetic tape apparatus 20 or 30 completes writing the data to or reading the data from the tape 51a, it makes the drive unit eject the tape 51a. The magnetic tape apparatus 20 or 30 then makes the transportation mechanism unit 40 house the tape 51a at its original position in the cartridge tape housing shelf 50.

The structure of the magnetic tape apparatus 20 and 30 will now be described in detail. The magnetic tape apparatus 20 and 30 are equal in structure, so the structure of the magnetic tape apparatus 20 will be described as a representative.

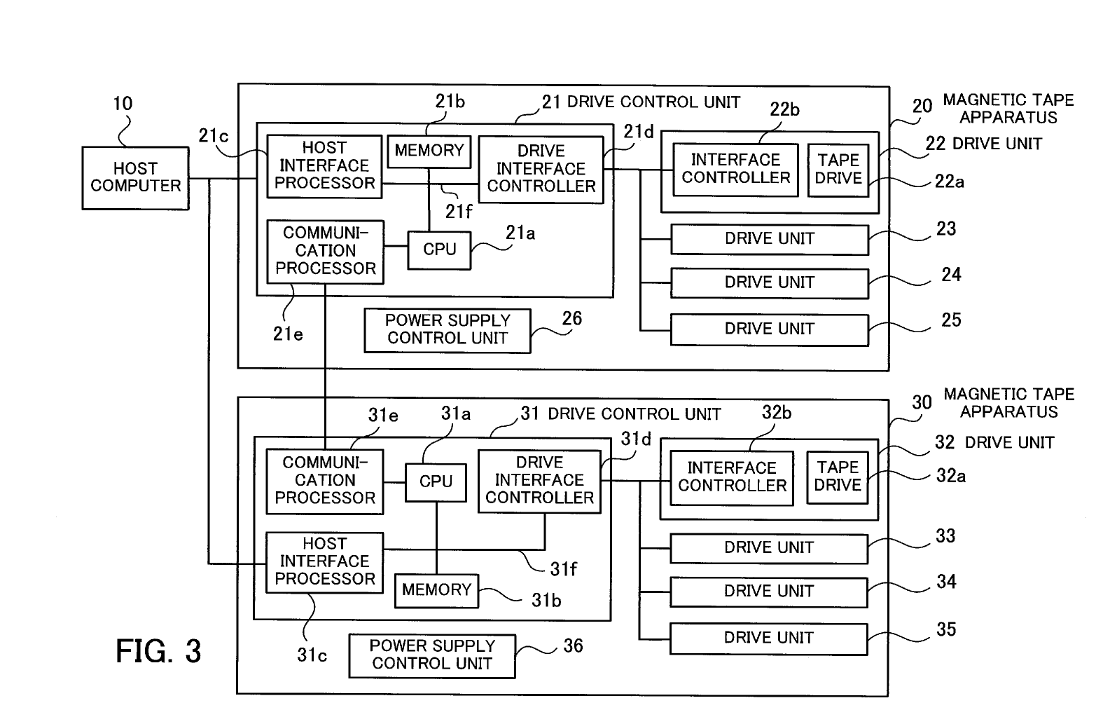

FIG. 3 is a block diagram of the structure of the magnetic tape apparatus.

The magnetic tape apparatus 20 includes a drive control unit 21, drive units 22, 23, 24, and 25, and a power supply control unit 26.

In accordance with instructions from the host computer 10 the drive control unit 21 gives each of the drive units 22, 23, 24, and 25 instructions to write or read data. Each of the drive units 22, 23, 24, and 25 writes or reads data by the block. In the second embodiment one block is 32 kB.

The drive control unit 21 includes a CPU 21a, a memory 21b, a host interface processor 21c, a drive interface controller 21d, and a communication processor 21e.

The CPU 21a controls the whole of the drive control unit 21. The memory 21b, the host interface processor 21c, and the drive interface controller 21d are connected to the CPU 21a via a bus 21f.

The memory 21b is used as main storage of the drive control unit 21. At least a part of an OS program or an application program executed by the CPU 21a is temporarily stored in the memory 21b. In addition, various pieces of data which the CPU 21a needs to perform a process are stored in the memory 21b.

The host interface processor 21c communicates with the host computer 10. For example, the host interface processor 21c accepts a command outputted from the host computer 10. A request transmitted from the host computer 10 is interpreted by the host interface processor 21c and is transmitted to the CPU 21a. In addition, the host interface processor 21c transmits to the host computer 10 a response indicative of a result of a process performed in the magnetic tape apparatus 20 in response to a request from the host computer 10.

The drive interface controller 21d is connected to an interface controller (interface controller 22b, for example) included in each of the drive units 22, 23, 24, and 25. The drive interface controller 21d exchanges data with each interface controller.

The communication processor 21e is connected to the CPU 21a. The communication processor 21e exchanges data with a communication processor 31e included in a drive control unit 31 in accordance with instructions from the CPU 21a.

Each of the drive units 22, 23, 24, and 25 has the function of reproducing data stored on a tape and the function of storing data on a tape.

The drive unit 22 includes a tape drive 22a having magnetic heads which is able to accommodate a maximum of 36 tape tracks. Hereinafter a drive unit including a tape drive which is able to accommodate a maximum of 36 tape tracks will be referred to as a “36TRK drive unit”. The drive unit 23 is a 36TRK drive unit.

Each of the drive units 24 and 25 includes a tape drive (not illustrated) having magnetic heads which is able to accommodate a maximum of 128 tape tracks. Hereinafter a drive unit including a tape drive which is able to accommodate a maximum of 128 tape tracks will be referred to as a “128TRK drive unit”.

The power supply control unit 26 supplies power supply for control and power supply for drive to the drive control unit 21 and the drive units 22, 23, 24, and 25.

Error handling performed in the library system 100 at the time of the occurrence of a data write error will now be described in brief.

When a data write error occurs in one of the drive units 22, 23, 24, and 25, the drive control unit 21 returns an error to the host computer 10. After that, the drive control unit 21 takes out a tape mounted on the drive unit in which the error has occurred by operating the transportation mechanism unit 40, and mounts it on another drive unit included in the magnetic tape apparatus 20.

Furthermore, when a data write error occurs, the drive control unit 21 informs the host computer 10 of the occurrence of the data write error.

The host computer 10 begins to perform a DDR process. To be concrete, the host computer 10 issues an RDBID command to the drive control unit 21.

If the host computer 10 is able to manage a physical block ID of a block in which the data write error has occurred, then the drive control unit 21 which receives the RDBID command returns the physical block ID to the RDBID command. On the other hand, if the physical block ID of the block in which the data write error has occurred is larger than a physical block ID which the host computer 10 is able to manage, then the drive control unit which receives the RDBID command returns a virtual block ID described later to the RDBID command.

After that, the host computer 10 issues to the drive control unit 21a LOCATE command for putting a magnetic head over a tape on which the data write error has occurred.

If the host computer 10 is able to manage the physical block ID of the block in which the data write error has occurred, then the drive control unit 21 which receives the LOCATE command gives a drive unit instructions to put the magnetic head over a position on a tape 51 specified by the physical block ID of the block in which the data write error has really occurred. On the other hand, if the physical block ID of the block in which the data write error has occurred is larger than a physical block ID which the host computer 10 is able to manage, then the magnetic head is put over a position on the tape 51 specified by a physical block ID which equals the virtual block ID in number.

Writing to the tape 51 is then performed again.

The functions of the drive control unit 21 will now be described in detail.

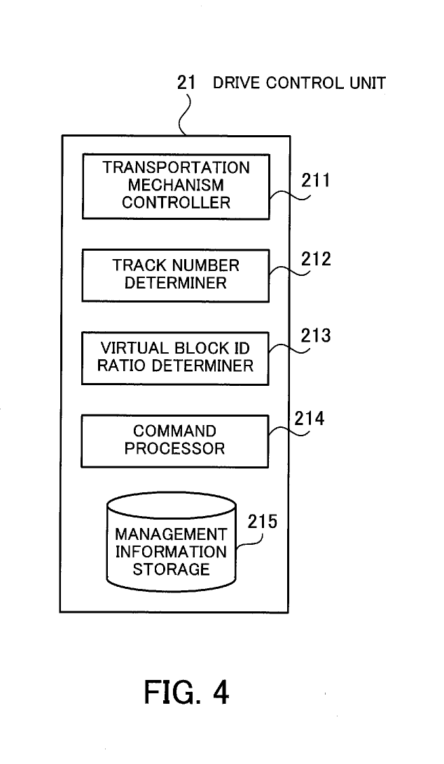

FIG. 4 is a block diagram of the functions of the drive control unit.

The drive control unit 21 includes a transportation mechanism controller 211, a track number determiner 212, a virtual block ID ratio determiner 213, a command processor 214, and management information storage 215.

The transportation mechanism controller 211 transmits to the transportation mechanism unit 40 a request which is transmitted from the host computer 10 and which is received via the host interface processor 21c. By doing so, the transportation mechanism controller 211 gives the transportation mechanism unit 40 operative instructions. The transportation mechanism unit 40 operates in accordance with the operative instructions. In addition, the transportation mechanism controller 211 transmits an operative result of the transportation mechanism unit 40 to the host interface processor 21c. On the basis of the operative result, a response to the request from the host computer 10 is transmitted to the host computer 10.

The track number determiner 212 determines the preset number of tape tracks which each of the drive units 22, 23, 24, and 25 is able to accommodate. This may be determined, for example, from the standards or the like for a magnetic head.

The virtual block ID ratio determiner 213 determines the ratio of virtual block IDs to physical block IDs for each of the drive units 22, 23, 24, and 25 of which the host computer 10 is informed at the time of the occurrence of a data write error.

This ratio is determined by the capacity of a tape mounted on each of the drive units 22, 23, 24, and 25.

In the second embodiment one block is 32 kB. Therefore, as stated above, if the host computer 10 is able to manage the physical block ID “3FFFFFh”, then the host computer 10 is able to manage a capacity of 137 GB (=2²²×32 kB).

For example, a G1 tape 51 has a capacity of 200

GB at compression time. As a result, the host computer 10 is unable to manage a position on a G1 tape 51 beyond 137 GB.

If two blocks are managed by one virtual block ID, then the drive control unit 21 is able to specify all positions on a G1 tape 51. Accordingly, if a G1 tape 51 is mounted, then the virtual block ID ratio determiner 213 determines a ratio of 1 to 2 which means that two blocks are managed by one virtual block ID.

If a G2 tape 51 (having a capacity of 400 GB at compression time) is mounted, then the virtual block ID ratio determiner 213 determines a ratio of 1 to 4 by the same determination method. If a G3 tape 51 (having a capacity of 800 GB at compression time) is mounted, then the virtual block ID ratio determiner 213 determines a ratio of 1 to 8 by the same determination method. If a G4 tape 51 (having a capacity of 1600 GB at compression time) is mounted, then the virtual block ID ratio determiner 213 determines a ratio of 1 to 16 by the same determination method.

In accordance with a command issued by the host computer 10, the command processor 214 controls the drive units 22, 23, 24, and 25.

The management information storage 215 stores drive type management information for managing the type of a drive unit, virtual block ID ratio management information for managing the ratio of virtual block IDs to physical block IDs, and block ID management information for managing error information.

Each piece of management information stored in the management information storage 215 will now be described.

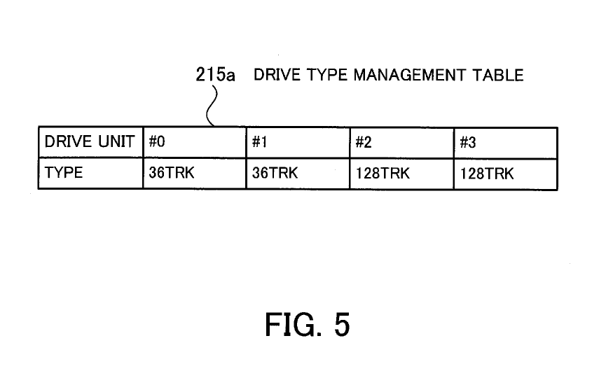

FIG. 5 indicates drive type management information. In FIG. 5, drive type management information is indicated in a table.

A drive type management table 215a includes Drive and Type rows. Pieces of information vertically arranged are associated with each other.

Information for identifying a drive unit is stored in the Drive row. For example, “#0” indicates information for identifying the drive unit 22. In addition, “#1” indicates information for identifying the drive unit 23.

Information for identifying the number of tape tracks which is able to be accommodated is stored in the Type row.

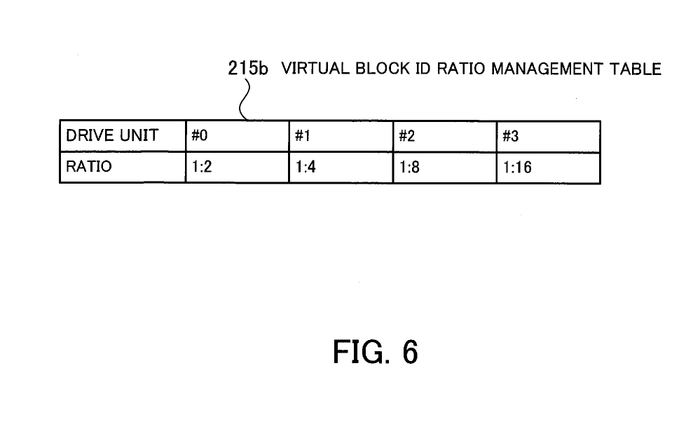

FIG. 6 indicates virtual block ID ratio management information. In FIG. 6, virtual block ID ratio management information is indicated in a table.

A virtual block ID ratio management table 215b includes Drive and Ratio rows. Pieces of information vertically arranged are associated with each other.

Information for identifying a drive unit is stored in the Drive row.

The ratio of virtual block IDs to physical block IDs reported to the host computer 10 according to a generation of a tape 51 currently mounted on a drive unit is stored in the Ratio row. To be concrete, if a G1 tape 51 is mounted, then 1 to 2 is stored. If a G2 tape 51 is mounted, then 1 to 4 is stored. If a G3 tape 51 is mounted, then 1 to 8 is stored. If a G4 tape 51 is mounted, then 1 to 16 is stored.

In FIG. 6, a G1 tape 51 is mounted on the drive unit 22, so “1 to 2” is stored in the Ratio row. A G2 tape 51 is mounted on the drive unit 23, so “1 to 4” is stored in the Ratio row. A G3 tape 51 is mounted on the drive unit 24, so “1 to 8” is stored in the Ratio row. A G4 tape 51 is mounted on the drive unit 25, so “1 to 16” is stored in the Ratio row. When a new tape is mounted on each drive unit, the Ratio row is rewritten to a generation of the mounted tape.

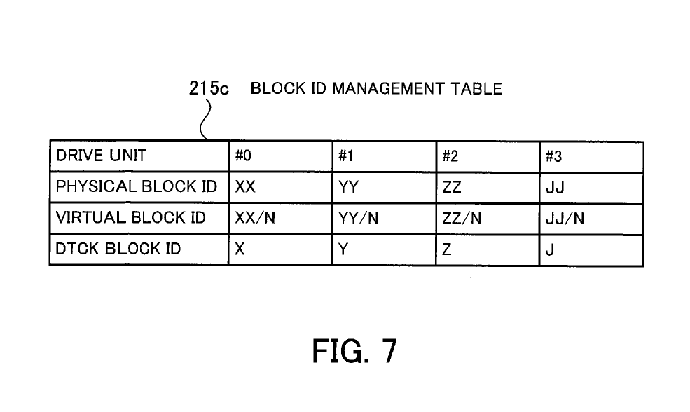

FIG. 7 indicates block ID management information. In FIG. 7, block ID management information is indicated in a table.

A block ID management table 215c includes Drive Unit, Physical Block ID, Virtual Block ID, and DTCK Block ID rows. Pieces of information vertically arranged are associated with one another.

Information for identifying a drive unit is stored in the Drive Unit row.

A physical block ID is stored in the Physical

Block ID row. An ID in this row is incremented when the command processor 214 receives a WR command.

An operation result obtained by dividing a physical block ID stored in the Physical Block ID row by a ratio managed in the virtual block ID ratio management table 215b is stored in the Virtual Block ID row. For example, if a ratio managed in the virtual block ID ratio management table 215b is 1 to 2, then an operation result of (physical block ID stored in Physical Block ID row)/2 is stored in the Virtual Block ID row.

If there is a remainder, then a value obtained by adding “1” to a quotient is stored.

A physical block ID of a block in which a data write error occurs is stored in the DTCK Block ID row.

A process performed by the drive control unit 21 will now be described.

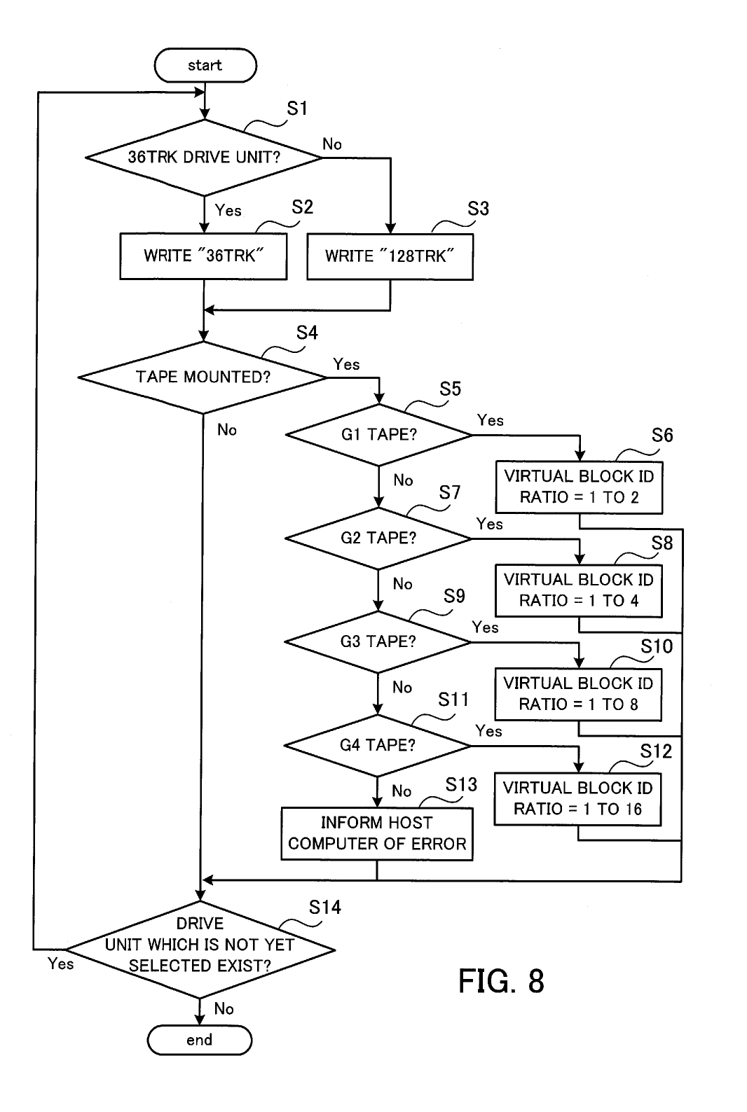

FIG. 8 is a flow chart of a process performed by the drive control unit.

(Step S1) Out of the drive units 22, 23, 24, and 25 connected to the drive control unit 21, the track number determiner 212 selects a drive unit which is not yet selected (on which steps S1 through S13 are not performed). The track number determiner 212 then determines whether on not the selected drive unit is a 36TRK drive unit. If the track number determiner 212 determines that the selected drive unit is a 36TRK drive unit (Yes in step S1), then the track number determiner 212 proceeds to step S2. If the track number determiner 212 determines that the selected drive unit is not a 36TRK drive unit (No in step S1), then the track number determiner 212 proceeds to step S3.

(Step S2) The track number determiner 212 writes “36TRK” to the Type row of the drive type management table 215a corresponding to the selected drive unit. After that, step S4 is performed.

(Step S3) The track number determiner 212 writes “128TRK” to the Type row of the drive type management table 215a corresponding to the selected drive unit. After that, step S4 is performed.

(Step S4) The virtual block ID ratio determiner 213 determines whether or not a tape 51 is mounted on the selected drive unit. If a tape 51 is mounted on the selected drive unit (Yes in step S4), then the virtual block ID ratio determiner 213 proceeds to step S5. If a tape 51 is not mounted on the selected drive unit (No in step S4), then the virtual block ID ratio determiner 213 proceeds to step S14.

(Step S5) The virtual block ID ratio determiner 213 determines whether or not the mounted tape 51 is a G1 tape. If the mounted tape 51 is a G1 tape (Yes in step S5), then the virtual block ID ratio determiner 213 proceeds to step S6. If the mounted tape 51 is not a G1 tape (No in step S5), then the virtual block ID ratio determiner 213 proceeds to step S7.

(Step S6) The virtual block ID ratio determiner 213 determines that the ratio of virtual block IDs to physical block IDs is 1 to 2. The virtual block ID ratio determiner 213 then writes the determined ratio to the Ratio row of the virtual block ID ratio management table 215b corresponding to the selected drive unit. After that, the virtual block ID ratio determiner 213 proceeds to step S14.

(Step S7) The virtual block ID ratio determiner 213 determines whether or not the mounted tape 51 is a G2 tape. If the mounted tape 51 is a G2 tape (Yes in step S7), then the virtual block ID ratio determiner 213 proceeds to step S8. If the mounted tape 51 is not a G2 tape (No in step S7), then the virtual block ID ratio determiner 213 proceeds to step S9.

(Step S8) The virtual block ID ratio determiner 213 determines that the ratio of virtual block IDs to physical block IDs is 1 to 4. The virtual block ID ratio determiner 213 then writes the determined ratio to the Ratio row of the virtual block ID ratio management table 215b corresponding to the selected drive unit. After that, the virtual block ID ratio determiner 213 proceeds to step S14.

(Step S9) The virtual block ID ratio determiner 213 determines whether or not the mounted tape 51 is a G3 tape. If the mounted tape 51 is a G3 tape (Yes in step S9), then the virtual block ID ratio determiner 213 proceeds to step S10. If the mounted tape 51 is not a G3 tape (No in step S9), then the virtual block ID ratio determiner 213 proceeds to step S11.

(Step S10) The virtual block ID ratio determiner 213 determines that the ratio of virtual block IDs to physical block IDs is 1 to 8. The virtual block ID ratio determiner 213 then writes the determined ratio to the Ratio row of the virtual block ID ratio management table 215b corresponding to the selected drive unit. After that, the virtual block ID ratio determiner 213 proceeds to step S14.

(Step S11) The virtual block ID ratio determiner 213 determines whether or not the mounted tape 51 is a G4 tape. If the mounted tape 51 is a G4 tape (Yes in step S11), then the virtual block ID ratio determiner 213 proceeds to step S12. If the mounted tape 51 is not a G4 tape (No in step S11), then the virtual block ID ratio determiner 213 proceeds to step S13.

(Step S12) The virtual block ID ratio determiner 213 determines that the ratio of virtual block IDs to physical block IDs is 1 to 16. The virtual block ID ratio determiner 213 then writes the determined ratio to the Ratio row of the virtual block ID ratio management table 215b corresponding to the selected drive unit. After that, the virtual block ID ratio determiner 213 proceeds to step S14.

(Step S13) The virtual block ID ratio determiner 213 informs the host computer 10 of an error. After that, the virtual block ID ratio determiner 213 proceeds to step S14.

(Step S14) The virtual block ID ratio determiner 213 determines whether or not among the drive units 22, 23, 24, and 25 connected to the drive control unit 21, there is a drive unit which is not yet selected. If there is a drive unit which is not yet selected (Yes in step S14), then step S1 is performed. The process is then repeated from step S1. If there is no drive unit which is not yet selected (No in step S14), then the process indicated in FIG. 8 ends.

Command processing will now be described.

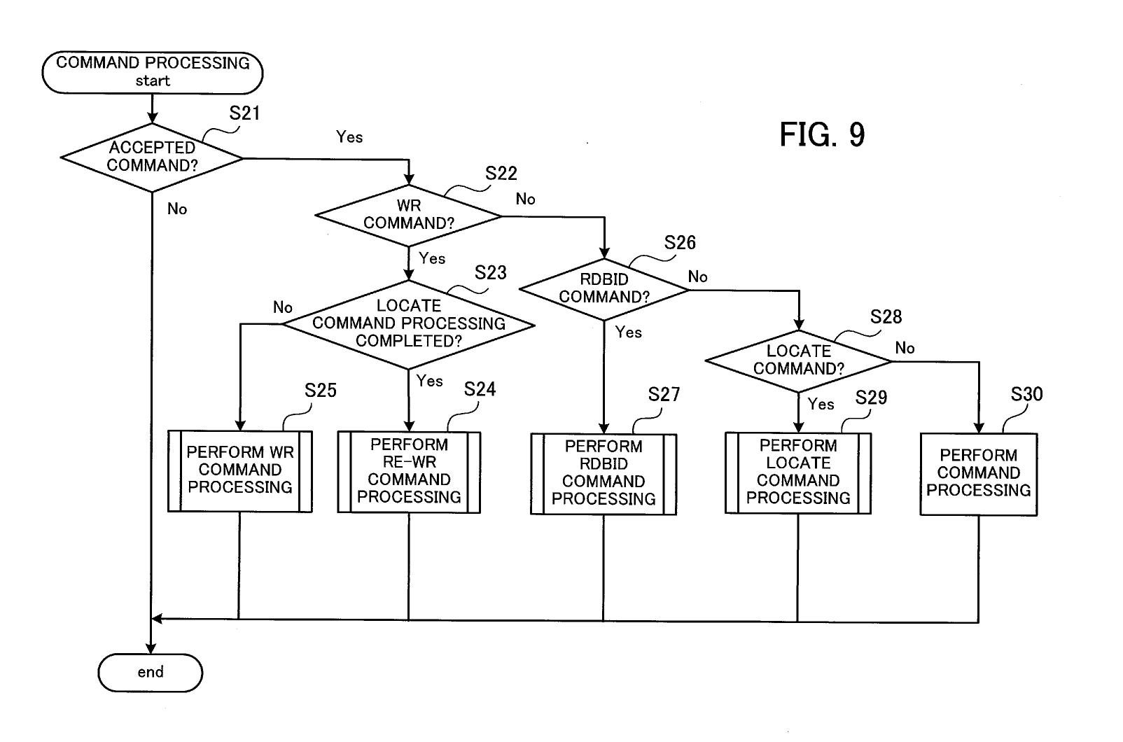

FIG. 9 is a flow chart of command processing.

(Step S21) The command processor 214 determines at intervals of a constant time whether or not it has accepted a command. If the command processor 214 determines that it has accepted a command (Yes in step S21), then the command processor 214 proceeds to step S22. If the command processor 214 determines that it has not accepted a command (No in step S21), then the command processor 214 ends command processing and waits to accept a command.

(Step S22) The command processor 214 determines whether or not the command which it has accepted is a WR command. If the command processor 214 determines that the command which it has accepted is a WR command (Yes in step S22), then the command processor 214 proceeds to step S23. If the command processor 214 determines that the command which it has accepted is not a WR command (No in step S22), then the command processor 214 proceeds to step S26.

(Step S23) The command processor 214 determines whether or not LOCATE command processing is completed. If LOCATE command processing is completed (Yes in step S23), then the command processor 214 proceeds to step S24. If LOCATE command processing is not completed (No in step S23), then the command processor 214 proceeds to step S25.

(Step S24) The command processor 214 performs re-WR command processing. After that, the command processor 214 ends command processing and waits to accept a command.

(Step S25) The command processor 214 performs WR command processing. After that, the command processor 214 ends command processing and waits to accept a command.

(Step S26) The command processor 214 determines whether or not the command which it has accepted is an RDBID command. If the command processor 214 determines that the command which it has accepted is an RDBID command (Yes in step S26), then the command processor 214 proceeds to step S27. If the command processor 214 determines that the command which it has accepted is not an RDBID command (No in step S26), then the command processor 214 proceeds to step S28.

(Step S27) The command processor 214 performs RDBID command processing. After that, the command processor 214 ends command processing and waits to accept a command.

(Step S28) The command processor 214 determines whether or not the command which it has accepted is a LOCATE command. If the command processor 214 determines that the command which it has accepted is a LOCATE command (Yes in step S28), then the command processor 214 proceeds to step S29. If the command processor 214 determines that the command which it has accepted is not a LOCATE command (No in step S28), then the command processor 214 proceeds to step S30.

(Step S29) The command processor 214 performs LOCATE command processing. After that, the command processor 214 ends command processing and waits to accept a command.

(Step S30) The command processor 214 performs command processing.

The WR command processing indicated in step S25 will now be described.

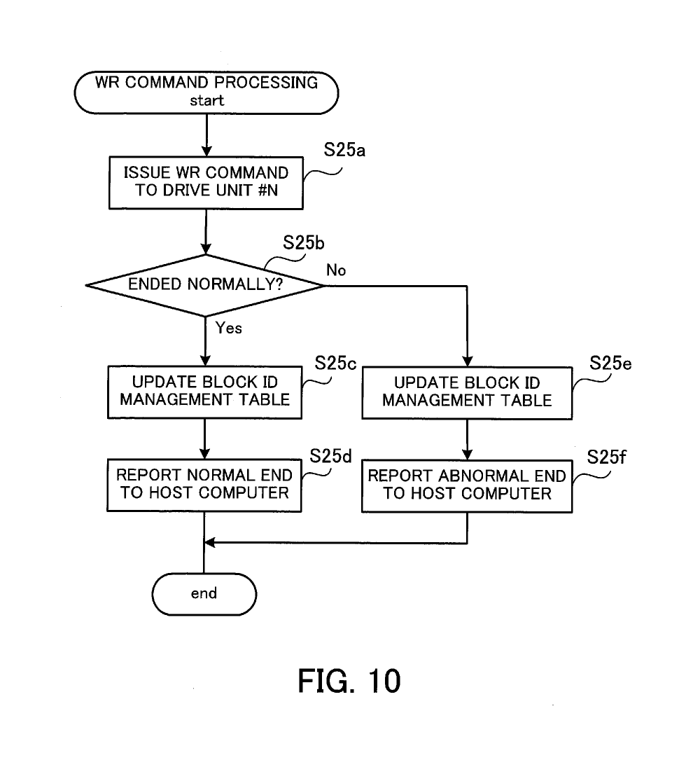

FIG. 10 is a flow chart of the WR command processing.

(Step S25a) The command processor 214 issues a WR command to a drive unit designated by the host computer 10. As a result, the drive unit writes onto a tape data designated by the WR command.

(Step S25b) On the basis of the presence or absence of a data write error report from the drive unit, the command processor 214 determines whether or not a write process has ended normally. If the command processor 214 determines that a write process has ended normally (Yes in step S25b), then the command processor 214 proceeds to step S25c. If the command processor 214 determines that a write process has ended abnormally (No in step S25b), then the command processor 214 proceeds to step S25e.

(Step S25c) The command processor 214 updates the Physical Block ID row of the block ID management table 215c. After that, the command processor 214 proceeds to step S25d.

(Step S25d) The command processor 214 reports a normal end to the host computer 10. After that, the command processor 214 ends WR command processing.

(Step S25e) The command processor 214 updates the Physical Block ID row of the block ID management table 215c. In addition, the command processor 214 updates the DTCK Block ID row of the block ID management table 215c to a block ID of a block in which the write process has ended abnormally. After that, the command processor 214 proceeds to step S25f.

(Step S25f) The command processor 214 reports an abnormal end to the host computer 10. After that, the command processor 214 ends WR command processing.

The RDBID command processing indicated in step S27 will now be described.

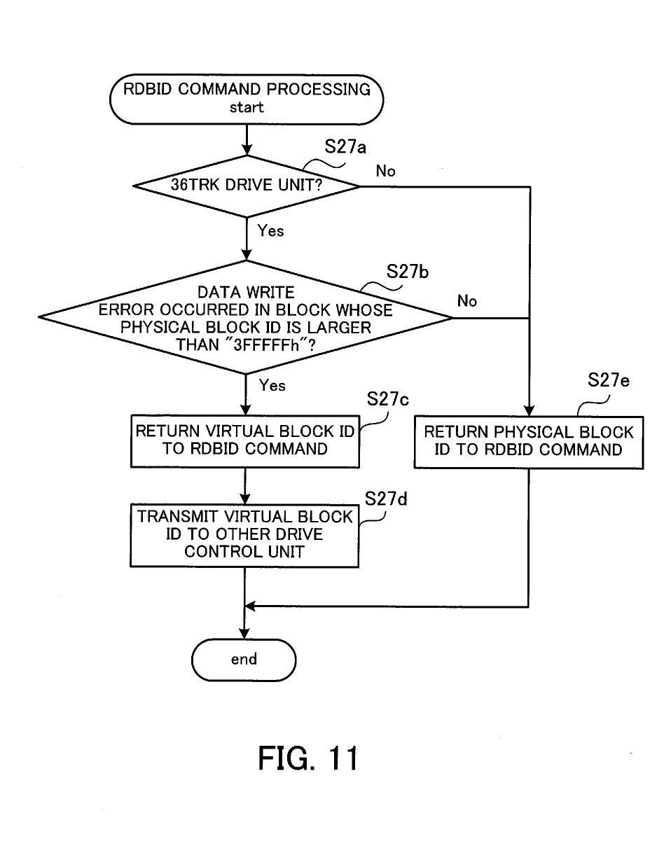

FIG. 11 is a flow chart of the RDBID command processing.

(Step S27a) The command processor 214 refers to the drive type management table 215a and determines whether on not a drive unit on which a tape 51 on which a data write error has occurred is mounted is a 36TRK drive unit. If the drive unit on which the tape 51 on which the data write error has occurred is mounted is a 36TRK drive unit (Yes in step S27a), then the command processor 214 proceeds to step S27b. If the drive unit on which the tape 51 on which the data write error has occurred is mounted is not a 36TRK drive unit (No in step S27a), then the command processor 214 proceeds to step S27e.

(Step S27b) The command processor 214 refers to the DTCK Block ID row of the block ID management table 215c and determines whether or not a physical block ID of a block on the tape 51 in which the data write error has occurred is above “3FFFFFh”. If the command processor 214 determines that a physical block ID of a block on the tape in which the data write error has occurred is larger than “3FFFFFh” (Yes in step S27b), then the command processor 214 proceeds to step S27c. If the command processor 214 determines that a physical block ID of a block on the tape 51 in which the data write error has occurred is smaller than or equal to “3FFFFFh” (No in step S27b), then the command processor 214 proceeds to step S27e.

(Step S27c) The command processor 214 refers to the virtual block ID ratio management table 215b and returns to the host computer 10 a virtual block ID based on a ratio for the drive unit on which the tape 51 on which the data write error has occurred is mounted. After that, the command processor 214 proceeds to step S27d.

(Step S27d) The command processor 214 transmits to the drive control unit 31 via the communication processor 21e notice to the effect that it returns the virtual block ID to the host computer 10 and the virtual block ID which it returns. After that, the process indicated in FIG. 11 ends.

(Step S27e) The command processor 214 returns the physical block ID of a position at which the data write error has occurred to the host computer 10 as a response to an RDBID command. After that, the process indicated in FIG. 11 ends.

The LOCATE command processing indicated in step S29 will now be described.

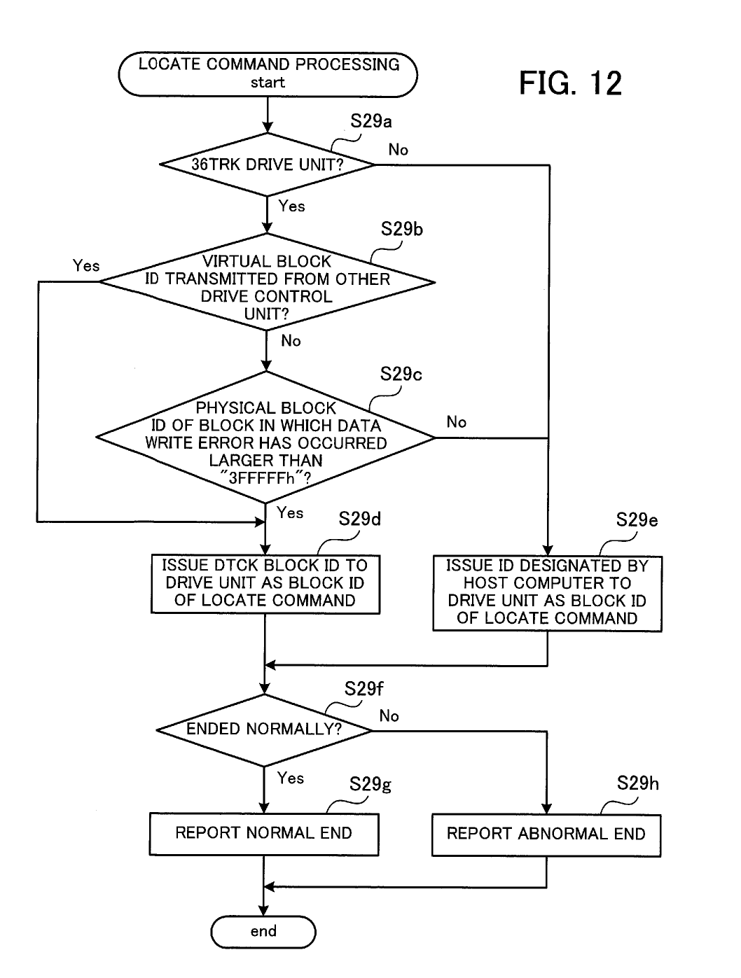

FIG. 12 is a flow chart of the LOCATE command processing.

(Step S29a) The command processor 214 refers to the drive type management table 215a and determines whether on not a drive unit on which a tape 51 on which a data write error has occurred is mounted is a 36TRK drive unit. If the drive unit on which the tape 51 on which the data write error has occurred is mounted is a 36TRK drive unit (Yes in step S29a), then the command processor 214 proceeds to step S29b. If the drive unit on which the tape 51 on which the data write error has occurred is mounted is not a 36TRK drive unit (No in step S29a), then the command processor 214 proceeds to step S29e.

(Step S29b) The command processor 214 determines whether on not it has received from the drive control unit 31 notice to the effect that the drive control unit 31 returns a virtual block ID to the host computer 10 and the virtual block ID which the drive control unit 31 returns as a result of RDBID command processing performed by the drive control unit 31. If the command processor 214 has received from the drive control unit 31 notice to the effect that the drive control unit 31 returns a virtual block ID to the host computer 10 and the virtual block ID which the drive control unit 31 returns (Yes in step S29b), then the command processor 214 proceeds to step S29d. If the command processor 214 has not received from the drive control unit 31 notice to the effect that the drive control unit 31 returns a virtual block ID to the host computer 10 and the virtual block ID which the drive control unit 31 returns (No in step S29b), then the command processor 214 proceeds to step S29c.

(Step S29c) The command processor 214 refers to the DTCK Block ID row of the block ID management table 215c and determines whether or not a physical block ID of a block on the tape 51 in which the data write error has occurred is larger than “3FFFFFh”. If a physical block ID of a block on the tape 51 in which the data write error has occurred is larger than “3FFFFFh” (Yes in step S29c), then the command processor 214 proceeds to step S29d. If a physical block ID of a block on the tape 51 in which the data write error has occurred is smaller than or equal to “3FFFFFh” (No in step S29c), then the command processor 214 proceeds to step S29e.

(Step S29d) The command processor 214 issues an ID stored in the DTCK Block ID row of the block ID management table 215c to the drive unit on which the tape 51 on which the data write error has occurred is mounted as a block ID of a LOCATE command. After that, the command processor 214 proceeds to step S29f.

(Step S29e) The command processor 214 issues an ID designated by the host computer 10 to the drive unit on which the tape 51 on which the data write error has occurred is mounted as a block ID of a LOCATE command. After that, the command processor 214 proceeds to step S29f.

(Step S29f) The command processor 214 determines whether or not writing data has ended normally. If the command processor 214 determines that writing data has ended normally (Yes in step S29f), then the command processor 214 proceeds to step S29g. If the command processor 214 determines that writing data has ended abnormally (No in step S29f), then the command processor 214 proceeds to step S29h.

(Step S29g) The command processor 214 reports a normal end to the host computer 10. After that, the process indicated in FIG. 12 ends.

(Step S29h) The command processor 214 reports an abnormal end to the host computer 10. After that, the process indicated in FIG. 12 ends.

The re-WR command processing indicated in step S24 will now be described.

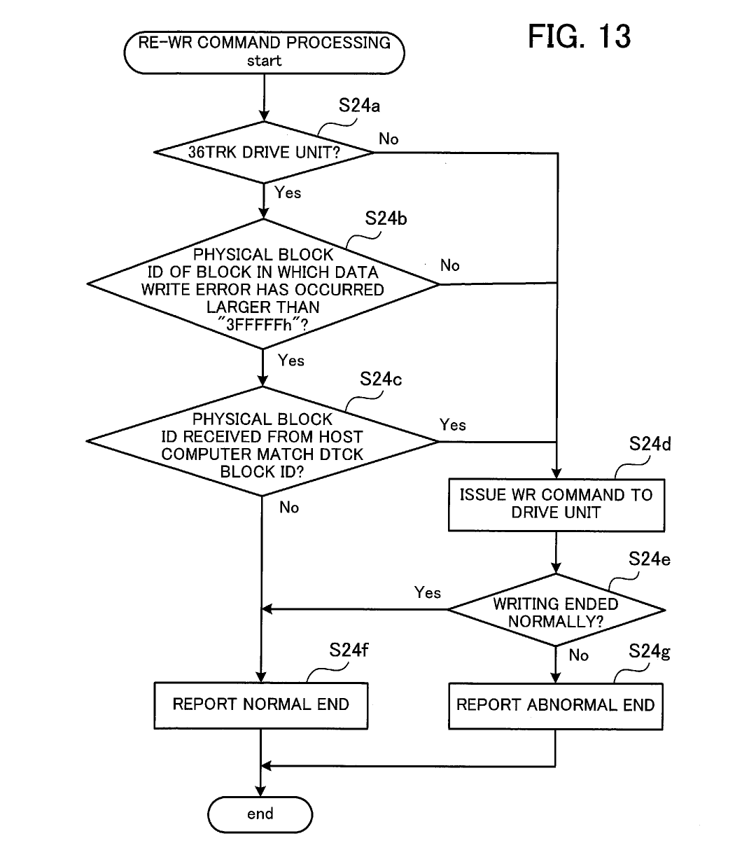

FIG. 13 is a flow chart of the re-WR command processing.

(Step S24a) The command processor 214 refers to the drive type management table 215a and determines whether on not a drive unit on which a tape 51 on which a data write error has occurred is mounted is a 36TRK drive unit. If the drive unit on which the tape 51 on which the data write error has occurred is mounted is a 36TRK drive unit (Yes in step S24a), then the command processor 214 proceeds to step S24b. If the drive unit on which the tape 51 on which the data write error has occurred is mounted is not a 36TRK drive unit (No in step S24a), then the command processor 214 proceeds to step S24d.

(Step S24b) The command processor 214 refers to the DTCK Block ID row of the block ID management table 215c and determines whether or not a physical block ID of a block on the tape 51 in which the data write error has occurred is larger than “3FFFFFh”. If the command processor 214 determines that a physical block ID of a block on the tape 51 in which the data write error has occurred is larger than “3FFFFFh” (Yes in step S24b), then the command processor 214 proceeds to step S24c. If the command processor 214 determines that a physical block ID of a block on the tape 51 in which the data write error has occurred is smaller than or equal to “3FFFFFh” (No in step S24b), then the command processor 214 proceeds to step S24d.

(Step S24c) The command processor 214 determines whether or not a physical block ID received from the host computer 10 matches an ID stored in the DTCK Block ID row of the block ID management table 215c. If a physical block ID received from the host computer 10 matches an ID stored in the DTCK Block ID row of the block ID management table 215c (Yes in step S24c), then the command processor 214 proceeds to step S24d. If a physical block ID received from the host computer 10 does not match an ID stored in the DTCK Block ID row of the block ID management table 215c (No in step S24c), then the command processor 214 proceeds to step S24f.

(Step S24d) The command processor 214 issues a WR command to the drive unit on which the tape 51 on which the data write error has occurred is mounted. As a result, the drive unit writes data onto the tape 51. After that, the command processor 214 proceeds to step S24e.

(Step S24e) The command processor 214 determines whether or not the writing by the drive unit of the data onto the tape 51 has ended normally. If the command processor 214 determines that the writing by the drive unit of the data onto the tape 51 has ended normally (Yes in step S24e), then the command processor 214 proceeds to step S24f. If the command processor 214 determines that the writing by the drive unit of the data onto the tape 51 has ended abnormally (No in step S24e), then the command processor 214 proceeds to step S24g.

(Step S24f) The command processor 214 reports a normal end to the host computer 10. After that, the process indicated in FIG. 13 ends.

(Step S24g) The command processor 214 reports an abnormal end to the host computer 10. After that, the process indicated in FIG. 13 ends.

### Concrete Example

A concrete example of command processing in the library system 100 will now be described.

In this concrete example a process performed in the library system 100 will be described with a case where the ratio of virtual block IDs to physical block IDs is set to 1 to 2 as an example.

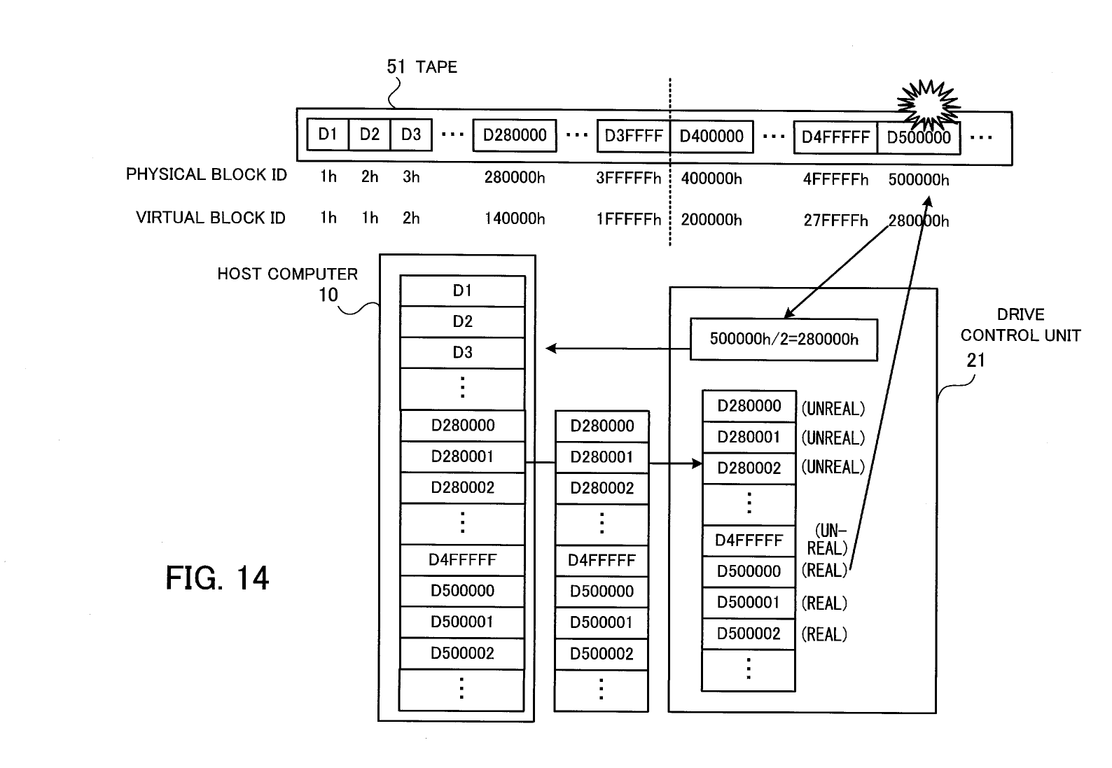

FIG. 14 is a concrete example of a process performed in the library system.

A tape 51 illustrated in FIG. 14 is mounted on the tape drive 22a. FIG. 14 indicates that data is sequentially written onto the tape 51 from data D1 and that writing succeeds from the data D1 to data D4FFFFF.

An error in writing data D500000 occurs, so the command processor 214 reports an abnormal end to the host computer 10.

The transportation mechanism controller 211 unmounts the tape 51 mounted on the drive unit 22, and replaces the drive unit 22 with the drive unit 23. The transportation mechanism controller 211 then mounts the tape 51 on the drive unit 23.

After that, the host computer 10 issues an RDBID command to the drive control unit 21.

The drive unit 23 is a 36TRK drive unit and a physical block ID of a block on the tape 51 in which the data write error has occurred is larger than “3FFFFFh”. Therefore, the command processor 214 which accepts the RDBID command returns the virtual block ID “280000h” to the host computer 10.

The host computer 10 which accepts the virtual block ID “280000h” issues the LOCATE command “LOCATE=280000h” to the drive control unit 21.

The physical block ID of the block on the tape in which the data write error has occurred is larger than “3FFFFFh”, so the command processor 214 which accepts the LOCATE command “LOCATE=280000h” puts the magnetic head over a position specified by the physical block ID “280000h” of a block on the tape 51 in which the data write error has not really occurred.

The host computer 10 then issues to the drive control unit 21 a re-WR command for writing data sequentially from the 280000hth data D280000.

The data D280000 through data D4FFFFF have already been written, so the command processor 214 which accepts the re-WR command does not write the data D280000 through the data D4FFFFF onto the tape 51. Instead, each time the command processor 214 receives a piece of data, the command processor 214 reports to the host computer 10 only the fact that writing has ended normally. In addition, the command processor 214 issues to the drive unit 23 a WR command for really writing data onto the tape 51 from the data D500000 on. As a result, the drive unit 23 writes data onto the tape 51. In FIG. 14, data which is not written is indicated by (unreal) and data which is written is indicated by (real).

As has been described, it is assumed that a data write error has occurred in the library system 100 and that a physical block ID of a block in which the data write error has occurred is smaller than or equal to a 22-bit value (3FFFFFh). In a DDR process, the physical block ID is used in an RDBID command. In addition, the magnetic head is put by a LOCATE command over a position specified by the physical block ID of the block in which the data write error has really occurred, and later writing is performed. If the physical block ID of the block in which the data write error has occurred is larger than a 22-bit value (3FFFFFh), then a virtual block ID is used in an RDBID command. Furthermore, the magnetic head is put by a LOCATE command over a position specified by a physical block ID of a block in which the data write error has not really occurred.

This makes it possible to write data beyond the limit of block ID management by an OS, and thus to increase a use area on a tape 51.

Furthermore, if the later writing (writing from the physical block ID which equals the virtual block ID in number) is performed by the OS, writing is unnecessary to the physical block ID of the block in which the data write error has really occurred. Accordingly, a normal end is returned for all physical block IDs to the physical block ID of the block in which the data write error has really occurred. This makes it possible to perform re-WR command processing at high speed.

The drive control apparatus, the drive control method, and the storage apparatus according to the present invention have been described on the basis of the embodiments illustrated. However, the present invention is not limited to these embodiments. The organization of each unit may be replaced with any organization having the same function. In addition, any other component or step may be added to the present invention.

Furthermore, the present invention may be a combination of any two or more of organizations (features) of the above embodiments.

The above processing functions may be realized with a computer. In this case, a program in which the contents of the processing functions the drive control apparatus 1 and the magnetic tape apparatus 20 and 30 have are described is provided. By executing this program on the computer, the above processing functions are realized on the computer. This program may be recorded on a computer-readable recording medium. A computer-readable recording medium may be a magnetic recording device, an optical disk, a magneto-optical recording medium, a semiconductor memory, or the like. A magnetic recording device may be a hard disk drive, a flexible disk (FD), a magnetic tape, or the like. An optical disk may be a DVD, a DVD-RAM, a CD-ROM/RW, or the like. A magneto-optical recording medium may be a magneto-optical disk (MO) or the like.

To place the program on the market, portable record media, such as DVDs or CD-ROMs, on which it is recorded are sold. Alternatively, the program is stored in advance on a hard disk in a server computer and is transferred from the server computer to another computer via a network.

When a computer executes this program, it will store the program, which is recorded on a portable record medium, which is transferred from the server computer, or the like, on its hard disk. The computer then reads the program from its hard disk and performs processes in compliance with the program. A computer may also read the program directly from a portable record medium and perform processes in compliance with the program. Furthermore, each time the program is transferred from the server computer connected via a network, a computer may perform processes in turn in compliance with the program it receives.

In addition, at least a part of above processing functions may be realized by an electronic circuit such as a digital signal processor (DSP), an application specific integrated circuit (ASIC), or a programmable logic device (PLD).

It is possible to increase a use area on a storage medium.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A drive control apparatus comprising:
a management unit which identifies a data write position on a medium onto which data is written sequentially and which manages correspondences between first addresses including an address larger than an address which is managed by a connected apparatus connected to the drive control apparatus and second addresses for making the connected apparatus identify the data write position on the medium;
a detection unit which detects that a drive which writes the data onto the medium fails in writing the data; and
an information unit which informs the connected apparatus of a second address of a position on the medium at which write fails based on detection by the detection unit.

2. The drive control apparatus according to claim 1 further comprising a write instruction unit which makes, at the time of receiving from the connected apparatus instructions to write data onto the medium from the second address, the drive write received data.

3. The drive control apparatus according to claim 2, wherein the write instruction unit instructs the drive not to write data onto the medium from a first address which equals in value the second address included in the received instructions to a first address corresponding to the second address, and instructs the drive to write data onto the medium from the first address corresponding to the second address managed by the management unit.

4. The drive control apparatus according to claim 1 further comprising a determination unit which determines the second addresses in a determined ratio to the first addresses according to a capacity of the medium.

5. The drive control apparatus according to claim 1, wherein:
when a first address of the position on the medium at which write fails is larger than a third address determined in advance, the information unit informs the connected apparatus of the second address; and
when the first address of the position on the medium at which write fails is smaller than the third address, the information unit informs the connected apparatus of the first address.

6. The drive control apparatus according to claim 5, wherein the third address is determined based on standards for the drive.

7. A drive control method comprising:
detecting that a drive which writes data onto a medium onto which the data is sequentially written fails in writing the data; and
identifying a data write position on the medium, managing correspondences between first addresses including an address larger than an address which is managed by a connected apparatus connected to a drive control apparatus and second addresses for making the connected apparatus identify the data write position on the medium, and informing the connected apparatus of a second address of a position on the medium at which write fails based on the detecting.

8. A storage apparatus comprising:
a drive which writes data onto a medium onto which the data is sequentially written;
a management unit which identifies a data write position on the medium and which manages correspondences between first addresses including an address larger than an address that is managed by a connected apparatus connected to a drive control apparatus and second addresses for making the connected apparatus identify the data write position on the medium;
a detection unit which detects that the drive which writes the data onto the medium fails in writing the data; and
an information unit which informs the connected apparatus of a second address of a position on the medium at which write fails based on detection by the detection unit.
